(19) United States
(12) Patent Application Publication
(10) Pub. No.: US 2013/0258690 A1
(43) Pub. Date: Oct. 3, 2013

(54) TAIL LAMP DEVICE FOR MOTORCYCLE

(71) Applicant: HONDA MOTOR CO., LTD., Tokyo (JP)

(72) Inventor: Tsuyoshi OGUCHI, Wako (JP)

(73) Assignee: HONDA MOTOR CO., LTD., Tokyo (JP)

(21) Appl. No.: 13/848,742

(22) Filed: Mar. 22, 2013

(30) Foreign Application Priority Data
Mar. 28, 2012 (JP) 2012-074589

(51) Int. Cl. B62J 6/04

(52) U.S. Cl. CPC B62J 6/04
USPC 362/473

(57) ABSTRACT

A tail lamp device for a motorcycle includes a first tail lamp bulb to emit light as a position light of the motorcycle. The first tail lamp bulb is arranged at a position either above or below a first exposed surface of the motorcycle in a vertical direction of a vehicle body of the motorcycle. The first exposed surface faces a rear side of the vehicle body through a first opening portion provided in a vehicle body cover. Only the first exposed surface forms a light emitting face for the first tail lamp bulb in the motorcycle. The first tail lamp bulb is provided to overlap with the vehicle body cover as viewed from the rear side of the vehicle body.

### CROSS-REFERENCE TO RELATED APPLICATIONS

The present application claims priority under 35 U.S.C. §119 to Japanese Patent Application No. 2012-074589, filed Mar. 28, 2012. The contents of this application are incorporated herein by reference in their entirety.

### BACKGROUND OF THE INVENTION

1. Field of the Invention

The present invention relates to a tail lamp device for a motorcycle.

2. Discussion of the Background

Conventionally, with respect to a tail lamp device which is mounted on a rear end of a motorcycle, there has been known the constitution where the external appearance of the motorcycle is enhanced by taking into account the manner of emission of light from a light emitting face such that a bulb portion which constitutes a light emitting source is not directly visible from the outside.

Japanese Unexamined Patent Application Publication No. JP-A-2009-206039 discloses a tail lamp device where a bulb is arranged at the center of a reflector which is arranged to face a lens in an opposed manner, and a non-light-transmitting cover member which is formed so as to conceal a center portion of the bulb is mounted outside the lens. Due to such a constitution, it is possible to make a light emitting face of the tail lamp uniformly emit light while preventing a possibility that only the bulb portion strongly emits light.

### SUMMARY OF THE INVENTION

According to one aspect of the present invention, a tail lamp device for a motorcycle includes a first tail lamp bulb to emit light as a position light of the motorcycle. The first tail lamp bulb is arranged at a position either above or below a first exposed surface of the motorcycle in a vertical direction of a vehicle body of the motorcycle. The first exposed surface faces a rear side of the vehicle body through a first opening portion provided in a vehicle body cover. Only the first exposed surface forms a light emitting face for the first tail lamp bulb in the motorcycle. The first tail lamp bulb is provided to overlap with the vehicle body cover as viewed from the rear side of the vehicle body.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings.

FIG. 1 is a right side view of a motorcycle to which a tail lamp device according to one embodiment is applied.

FIG. 2 is a rear view of the motorcycle.

FIG. 3 is an enlarged rear view of the motorcycle.

FIG. 4 is an explanatory view of the structure of a tail lamp device in a state where an outer lens and an inner lens are removed.

FIG. 5 is a front view of the tail lamp device.

FIG. 6 is a right side view of the tail lamp device.

FIG. 7 is a plan view of the tail lamp device.

FIG. 8 is a rear view of the tail lamp device.

FIG. 9 is a front view of the tail lamp device in a state where the outer lens is removed.

FIG. 10 is a perspective view of the tail lamp device in a state where the outer lens and the inner lens are removed.

FIG. 11 is a cross-sectional view taken along a line 11-11 in FIG. 3.

FIG. 12 is a cross-sectional view taken along a line 12-12 in FIG. 3.

FIG. 13 is a cross-sectional view taken along a line 13-13 in FIG. 3.

FIG. 14 is a cross-sectional view taken along a line 14-14 in FIG. 3.

### DESCRIPTION OF THE EMBODIMENTS

The embodiments will now be described with reference to the accompanying drawings, wherein like reference numerals designate corresponding or identical elements throughout the various drawings.

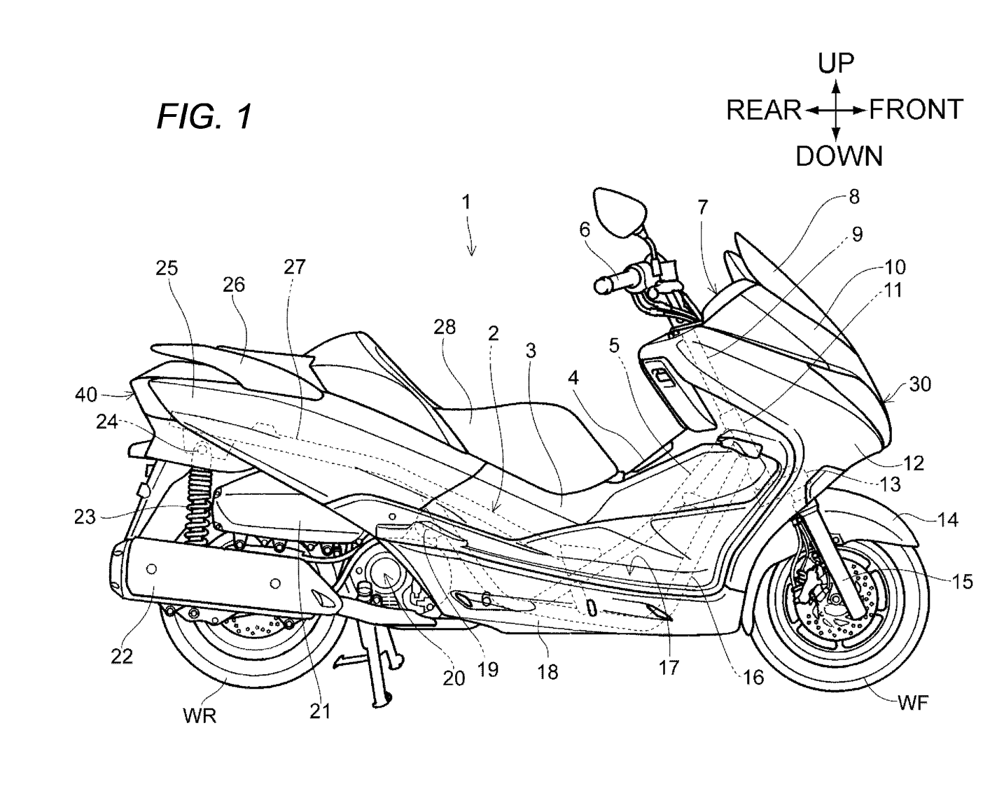

FIG. 1 is a right side view of a motorcycle 1 to which a tail lamp device according to one embodiment is applied. A vehicle body frame 2 includes a head pipe 11 which rotatably and pivotally supports a steering stem 9, a pair of left and right main frames 5 and a pair of left and right under frames 16 which extend toward a rear lower side of a vehicle body from the head pipe 11, and a rear frame 27 which is connected to a rear side of the main frames 5.

An under bracket 13 which supports a pair of left and right front forks 15 is fixed to a lower end portion of the steering stem 9. On the other hand, a steering handle 6 is mounted on an upper end portion of the steering stem 9. A front wheel WF is rotatably and pivotally supported on a lower end portion of the front fork 15.

A pivot shaft 19 is mounted on a connecting portion between rear end portions of the main frames 5 and the rear frame 27. A unit swing 20 which is an integral body constituted of an engine and an automatic transmission is swingably and pivotally supported on the pivot shaft 19. A rear wheel WR which constitutes a drive wheel is rotatably and pivotally supported on the unit swing 20, and an air cleaner box 21 and a muffler 22 are supported on the unit swing 20. A rear side of the unit swing 20 is suspended from a pair of left and right rear cushions 23 which is swingably supported on a support portion 24 formed on the rear frame 27.

On a front side of the head pipe 11, a front cowl 10 having a wind screen 8 and a pair of left and right front side cowls 12 are mounted. A front lamp (headlight unit) 30 is arranged at a position between both cowls 10, 12. A meter device 7 is arranged behind the wind screen 8, and a front fender 14 which is supported on the front forks 15 is arranged above and behind the front wheel WF.

A floor panel 3 which has a straddling portion 4 raised toward an upper side of the vehicle body at the center position in the vehicle widthwise direction and a pair of left and right foot placement floors 17 is provided behind the head pipe 11, and a seat 28 is mounted above the floor panel 3. An under cowl 18 is provided below the foot placement floors 17, and a pair of left and right rear side cowls 25 is mounted on a rear portion of the floor panel 3. A tail lamp device 40 (tail lamp unit) is arranged behind the rear side cowls 25. A passenger grip 26 is mounted on a rear side of the seat.

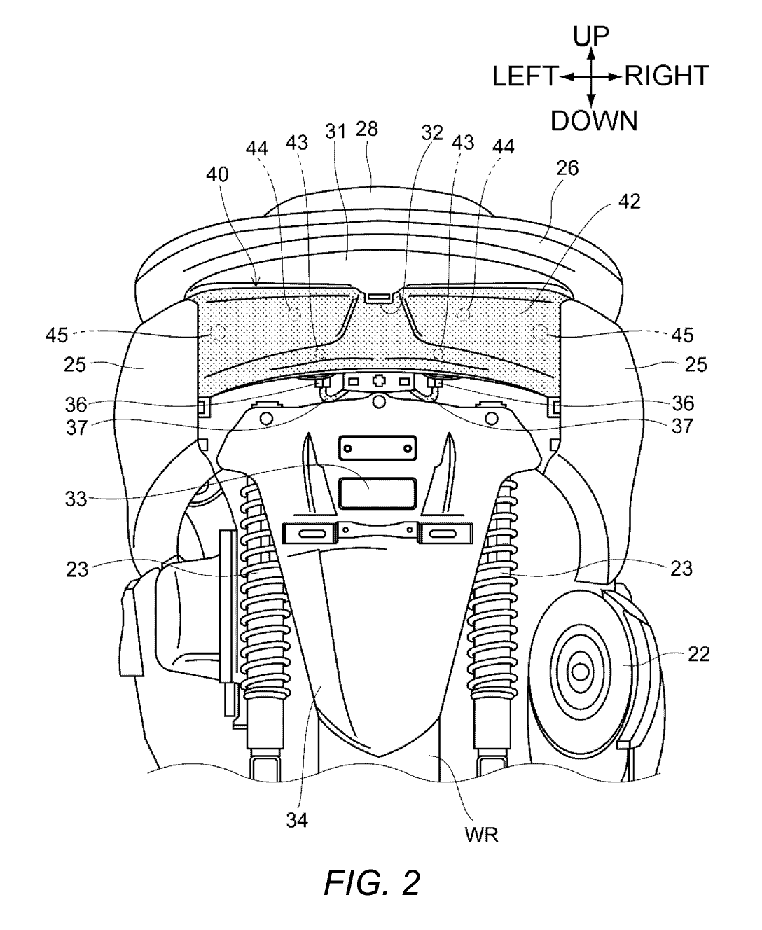

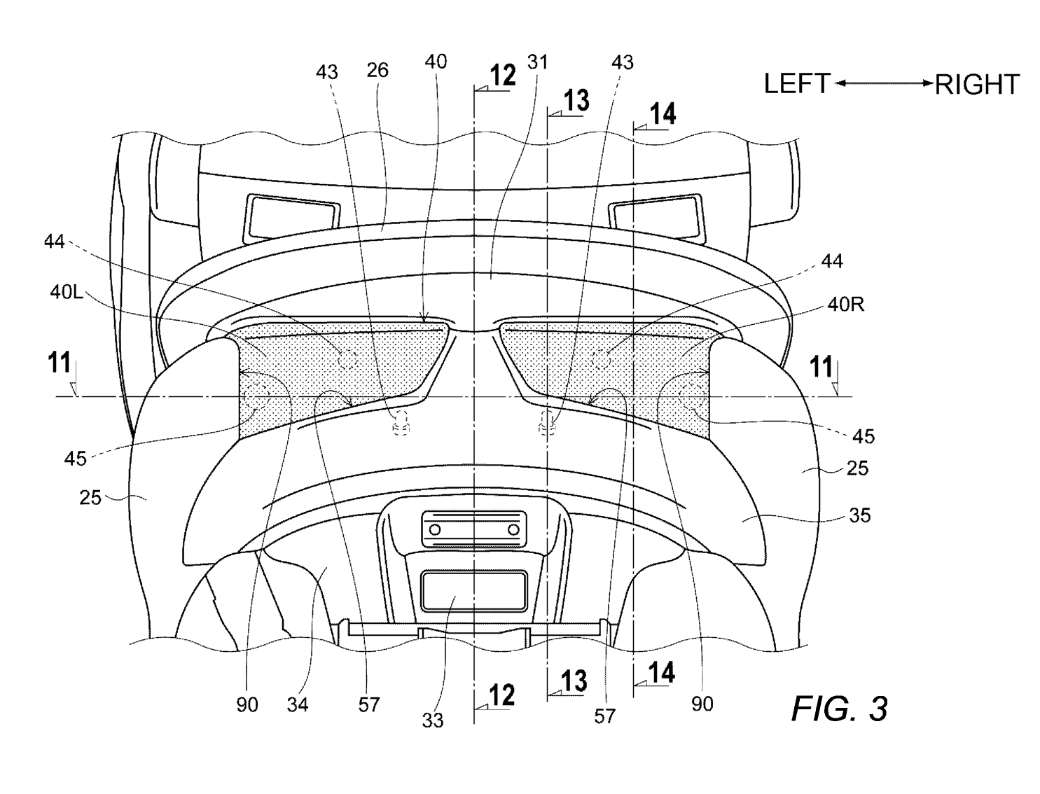

FIG. 2 is a rear view of the motorcycle 1. FIG. 3 is an enlarged rear view of the motorcycle 1. An upper cover 31 is arranged between the passenger grip 26 and the tail lamp device 40. A lower cover 35 having a shape which allows the lower cover 35 to cover a portion of the tail lamp device 40 is arranged on a lower portion of the tail lamp device 40. FIG. 2 shows a state where the lower cover 35 is removed.

The tail lamp device 40 is configured such that only exposed surfaces 40L, 40R (meshed portions shown in FIG. 3) which form light emitting faces are visible through approximately rectangular opening portions 90 defined by the upper cover 31, the lower cover 35 and the pair of left and right rear side cowls 25 which constitute a vehicle body cover. The lower cover 35 forms lower edges 57 of the opening portions 90 and a distal end of a portion of the lower cover 35 which is arranged at the center in the vehicle widthwise direction and extends toward an upper side of the vehicle body so as to conceal the tail lamp device 40 is engaged with an engaging portion 32 formed on the upper cover 31.

The tail lamp device 40 is configured such that a pair of left and right tail lamps which constitutes position lamps, a pair of left and right brake lamps which constitutes braking lamps and a pair of left and right blinker devices which constitutes direction indication lamps are housed in a single housing. Blinker lamp bulbs 45 are arranged on outer sides of the exposed surfaces 40L, 40R in the vehicle widthwise direction respectively and, further, brake lamp bulbs 44 are arranged at the approximate center of the exposed surfaces 40L, 40R respectively. Tail lamp bulbs 43 are arranged at positions outside the exposed surfaces 40L, 40R where the tail lamp bulbs 43 are covered with the lower cover 35. The tail lamp device 40 according to the embodiment is characterized by being configured such that the tail lamp bulbs 43 are arranged outside the exposed surfaces 40L, 40R so that the tail lamp bulbs 43 are not visible from the outside.

A rear fender 34 and a license lamp 33 are mounted on a lower portion of the lower cover 35. Further, as shown in FIG. 2, when the lower cover 35 is removed from the vehicle body, sockets 36 of the tail lamp bulbs 43 and lines 37 are exposed on a lower portion of the tail lamp device 40 and hence, changing the tail lamp bulbs 43 can be done easily.

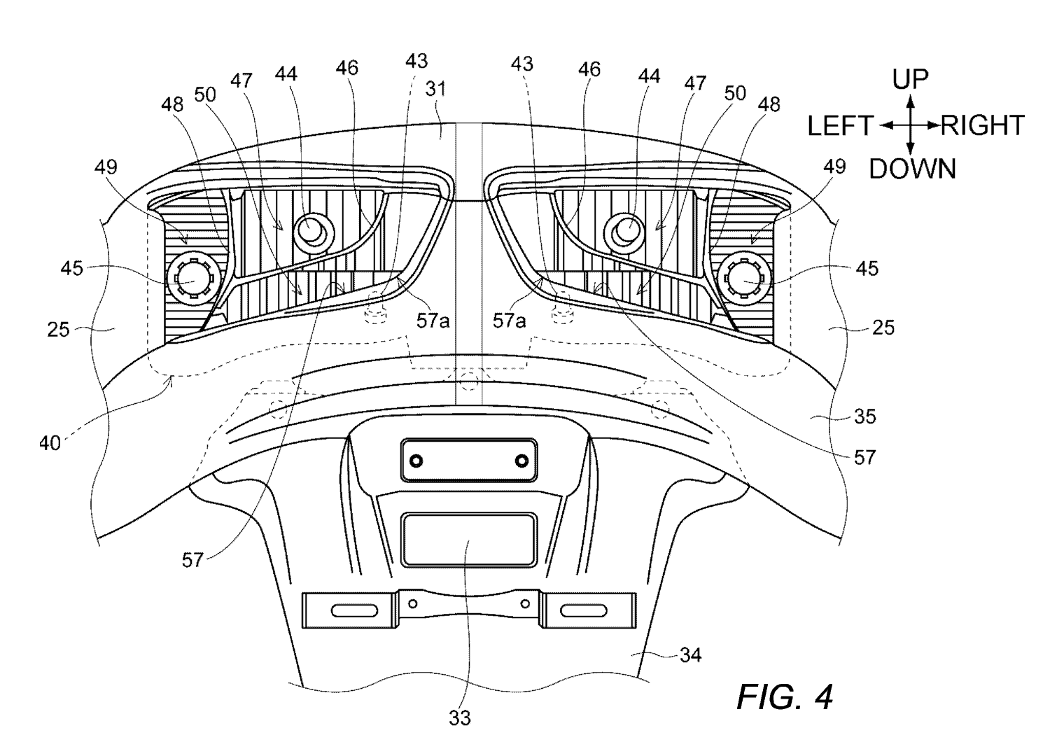

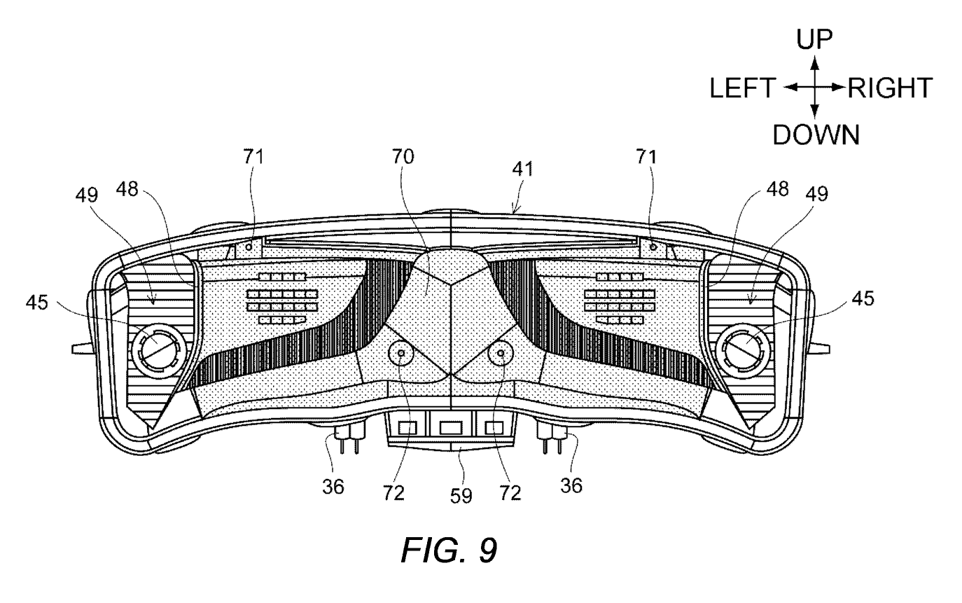

FIG. 4 is an explanatory view of the structure of the tail lamp device 40 in a state where an outer lens 42 and an inner lens 70 (see FIG. 9) are removed. The tail lamp bulb 43, the brake lamp bulb 44 and the blinker lamp bulb 45 are respectively housed in reflector portions partitioned by partition plates 46, 48. To be more specific, the tail lamp bulb 43 is housed in a tail lamp reflector portion 50, the brake lamp bulb 44 is housed in a brake lamp reflector portion 47, and the blinker lamp bulb 45 is housed in a blinker lamp reflector portion 49. On the respective reflector portions 47, 49 and 50, reflection surfaces having different stepped shapes from each other are formed.

Here, the brake lamp reflector portion 47 and the blinker lamp reflector portion 49 fall within an area of the exposed surface 40L, 40R, while with respect to the tail lamp reflector portion 50, a portion of the tail lamp reflector portion 50 appears within the exposed surface 40L, 40R and other portions of the tail lamp reflector portion 50 are concealed by the lower cover 35. Due to such a constitution, it is possible to prevent the tail lamp bulb 43 from being directly visible from the outside without additionally providing a cover member which covers the tail lamp bulb 43. Accordingly, the increase in the number of parts can be prevented, and a light emitting face can ensure a sufficient area.

Further, the respective lower edges 57 of the opening portions 90 are formed in a downwardly inclined manner toward the outside in the vehicle widthwise direction, and the tail lamp bulbs 43 are arranged at the positions close to the center in the vehicle widthwise direction. Due to such a constitution, the tail lamp bulbs 43 can be arranged in an approximately triangular region formed at the center in the vehicle widthwise direction and below the opening portions 90. Accordingly, the tail lamp bulbs 43 can be arranged below the opening portions 90 while inhibiting a size of the tail lamp device in the vertical direction. In this embodiment, a portion of the tail lamp reflector portion 50 which extends over the area of the exposed surface 40L, 40R is formed into an approximately L shape as an elongated shape having a bent portion, and the tail lamp bulb 43 is arranged close to the bent portion. Alternatively, the tail lamp bulb 43 is arranged in the vicinity of an L-shaped corner portion 57a of the tail lamp reflector portion 50 and hence, it is possible to make the whole tail lamp reflector portion 50 having an elongated shape emit light uniformly.

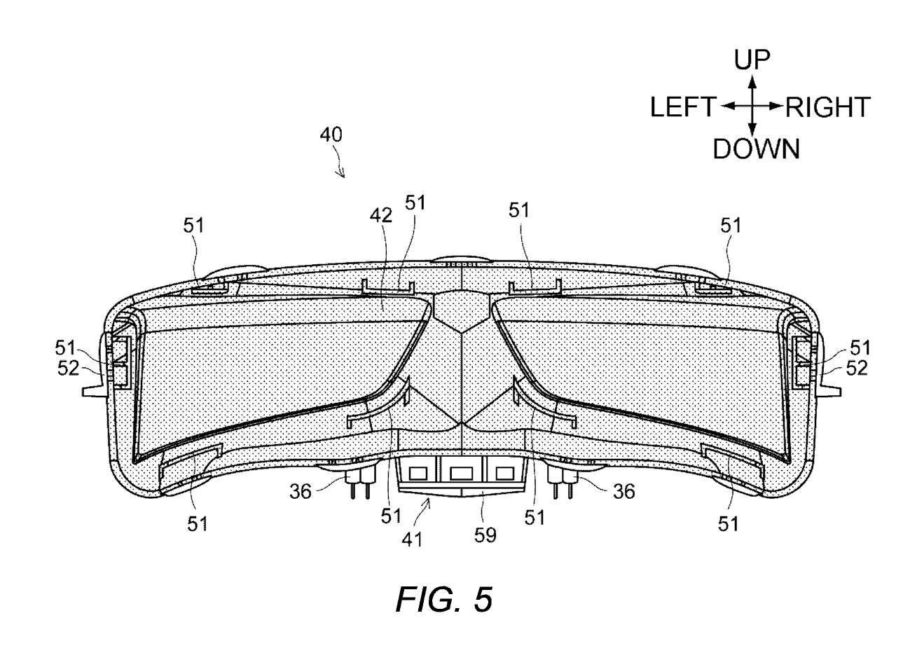

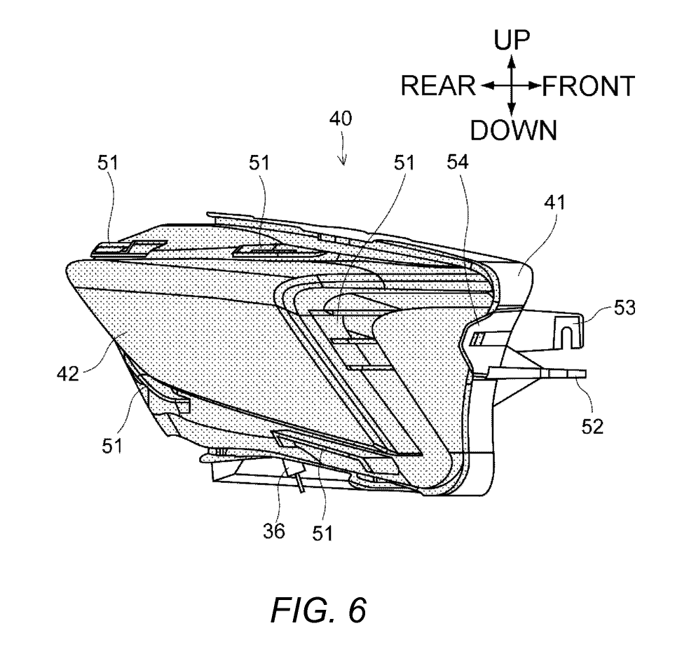

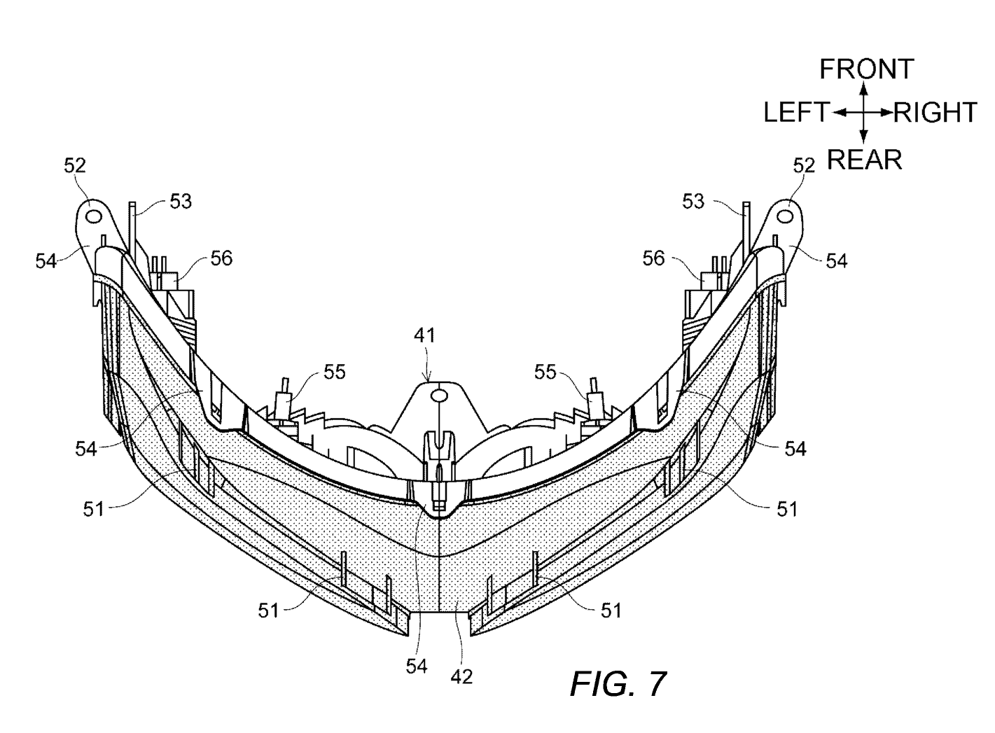

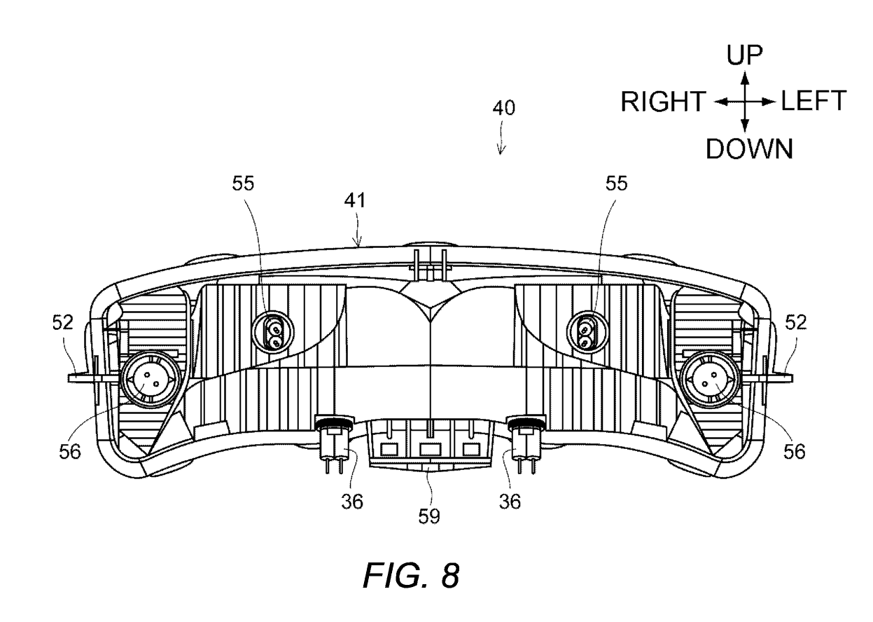

FIG. 5 is a front view of the tail lamp device 40. FIG. 6 is a right side view of the tail lamp device 40, FIG. 7 is a plan view of the tail lamp device 40, and FIG. 8 is a rear view of the tail lamp device 40. The tail lamp device 40 is configured such that the inner lens 70 (see FIG. 9) formed using a red transparent resin or the like and the outer lens 42 formed using a non-colored transparent resin or the like (meshed portion in the drawing) are mounted on the housing 41 formed using a colored resin or the like.

Around approximately rectangular portions which define the exposed surfaces 40L, 40R shown in FIG. 3, five engaging pawls 51 are formed on the outer lens 42 on each side. The periphery of the opening portion 90 (see FIG. 3) is positioned by the engaging pawls 51. The portion which forms the exposed surface 40L, 40R is formed in a projecting manner toward a rear side of the vehicle body. An engaging flange 59 which is engaged with the lower cover 35 by means of a center engaging hole and left and right positioning holes is formed on a lower portion of the housing 41. Engaging pawls 54 which are engaged with an outer edge portion of the outer lens 42 are formed around the housing 41 at nine positions in total, that is, at three positions on an upper surface, at two positions on a side, and at four positions on a lower surface. The housing 41 and the outer lens 42 are engaged with each other by the engaging pawls 54 and, thereafter, are joined to each other by welding at a plurality of positions.

As shown in FIG. 7, the tail lamp device 40 has a curved shape projecting toward a rear side of the vehicle body as viewed in a plan view, and engaging stays 52, 53 which are engaged with the rear side cowls 25 (see FIG. 3) are formed on both end portions of the tail lamp device 40. Further, as shown in FIG. 8, the socket 36 of the tail lamp bulb 43 is inserted and fixed from a vehicle-body lower side of the housing 41, and a socket 55 of the brake lamp bulb 44 and a socket 56 of the blinker lamp bulb 45 are inserted and fixed from a vehicle-body front side of the housing 41.

FIG. 9 is a front view of the tail lamp device 40 in a state where the outer lens 42 is removed. In this embodiment, the red transparent inner lens 70 is used, an orange bulb is adopted as the blinker lamp bulb 45, and the non-colored transparent outer lens 42 is adopted so that the tail lamp device 40 can acquire a particular external appearance. A white bulb is applied to the tail lamp bulb 43 and the brake lamp bulb 44. A lens cut which diffuses an illumination light into the predetermined direction is applied to the inner lens 70. The inner lens 70 is welded to the housing 41 at a plurality of positions and, thereafter, is fastened to the outer lens 41 by small bolts by way of an upper fixing portion 71 and a lower fixing portion 72.

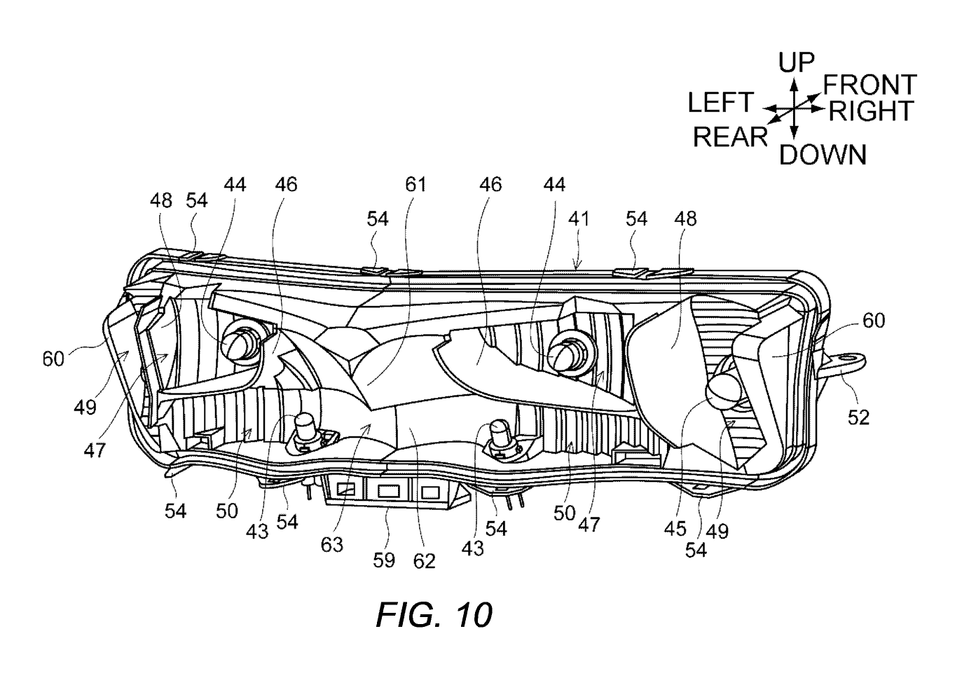

FIG. 10 is a perspective view of the tail lamp device 40 in a state where the outer lens 42 and the inner lens 70 are removed. As described previously, the tail lamp reflector portion 50 and the brake lamp reflector portion 47 are partitioned by the partition plate 46 which is inclined downwardly toward the outside in the vehicle widthwise direction so as to prevent illumination lights from both portions from interfering with each other. In the same manner, the tail lamp reflector portion 50, the brake lamp reflector portion 47 and the blinker lamp reflector portion 49 are partitioned by the partition plate 48 which is directed in the vertical direction of the vehicle body. Further, a light blocking plate 60 which restricts a diffusion range of light from the blinker lamp bulb 45 in the vehicle widthwise direction is arranged outside the blinker lamp reflector portion 49 in the vehicle widthwise direction.

A raised portion 61 which is raised toward a rear side of the vehicle body and the partition plate 46 are arranged between the left and right brake lamp reflector portions 47 and hence, there is no possibility that illumination lights from the left and right brake lamp reflector portions 47 interfere with each other. On the other hand, only a light guiding projecting portion 62 which guides an illumination light is arranged between the left and right tail lamp reflector portions 50 so that the left and right tail lamp reflector portions 50 are communicated with each other in the vehicle widthwise direction by a communication portion 63. Due to such a constitution, an illumination light of the tail lamp bulb 43 on one side reaches the reflector portion 50 on the other side so that it is possible to easily make the left and right reflector portions emit light uniformly.

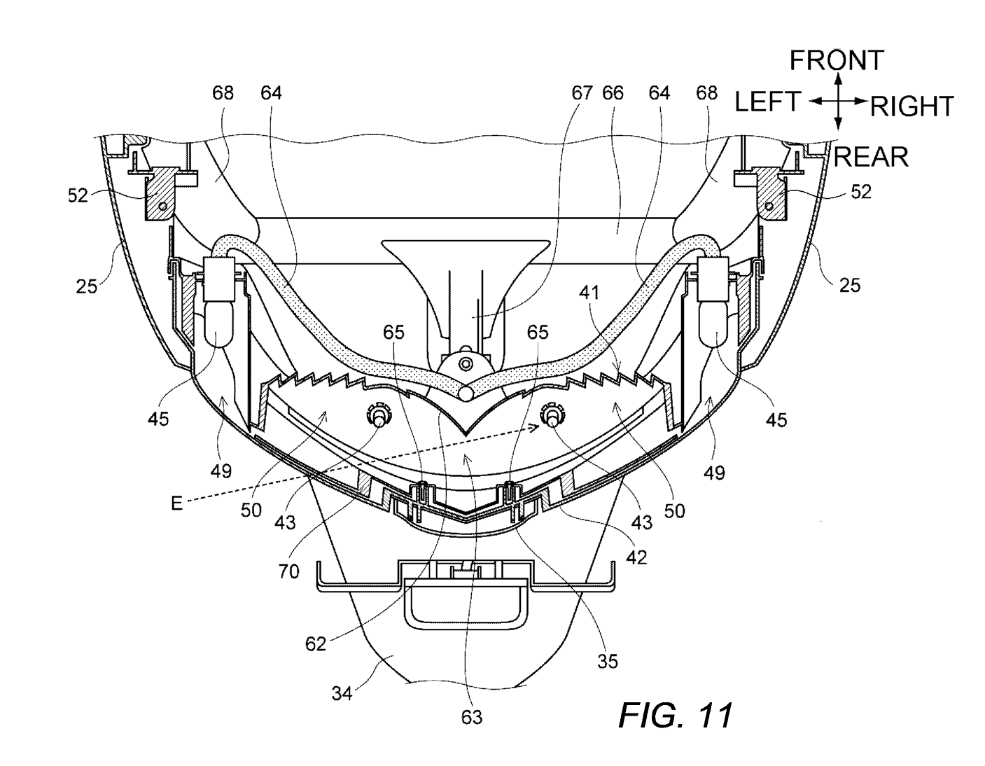

FIG. 11 is a cross-sectional view taken along a line 11-11 in FIG. 3. The tail lamp device 40 is fixed to a stay 67 which extends from a vehicle body frame at a center portion of the housing 41 in the vehicle widthwise direction. The stay 67 is fixed to a cross member 66 which connects left and right auxiliary frames 68 mounted on the rear frame 27 (see FIG. 1). Lines 64 which are connected to the sockets 56 of the blinker lamp bulbs 45 are bundled with lines for other bulbs at the center in the vehicle widthwise direction. The inner lens 70 is fixed to the outer lens 42 by four fastening bolts 65 directed toward a rear side of the vehicle body besides welding. In the drawing, two fastening screws 65 which are threaded into the lower fixing portion 72 are shown.

As described previously, the left and right tail lamp reflector portions 50 are communicated with each other in the vehicle width direction by the communication portion 63 so that an illumination light of the tail lamp bulb 43 on one side reaches the reflector portion 50 on the other side. Due to such a constitution, it is possible to make the left and right reflector portions 50 emit light uniformly. Further, although the center of the tail lamp device 40 in the vehicle widthwise direction is concealed by the lower cover 35 when the tail lamp device 40 is viewed from a rear side of the vehicle body, for example, when the exposed surface on a left side is viewed from the direction E shown in the drawing, the tail lamp bulb 43 on a right side can be visually recognized. Accordingly, it is possible to acquire the tail lamp device 40 having a peculiar light distribution characteristic.

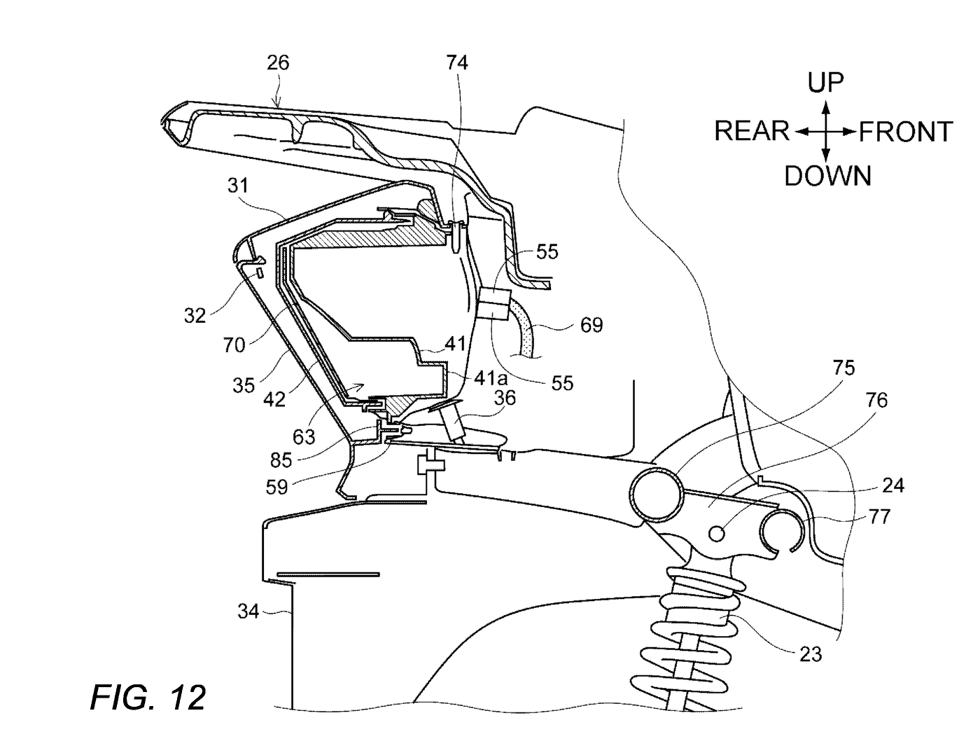

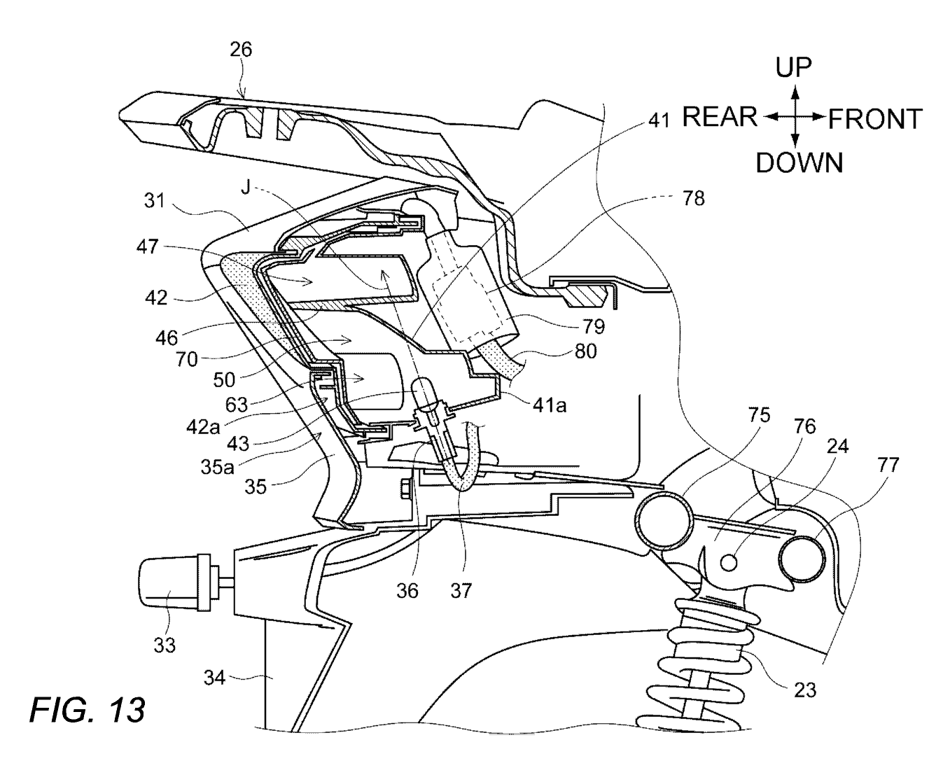

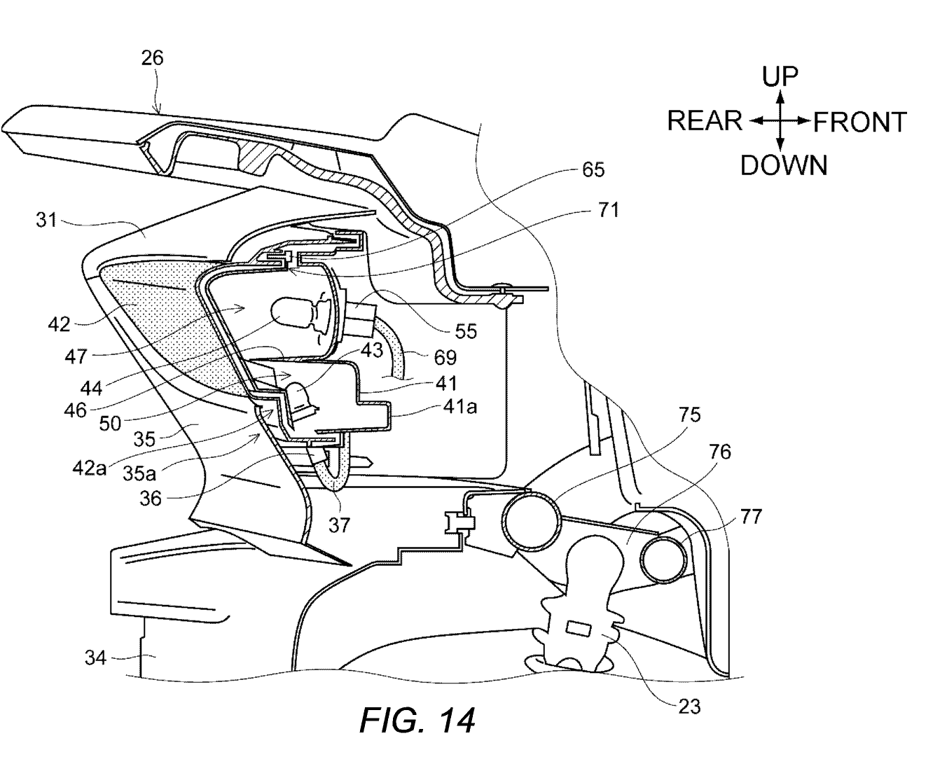

FIG. 12 is a cross-sectional view taken along a line 12-12 in FIG. 3. The passenger grip 26 is made of metal such as aluminum and has a hollow structure. The support portion 24 of the rear cushion 23 is mounted on a support plate 76 which is arranged between auxiliary frames 75, 77 mounted on the rear frame 27. The upper cover 31 is fixed to the housing 41 of the tail lamp device 40 by fastening bolts 74 on a front side thereof in the longitudinal direction of the vehicle body, and is engaged with the lower cover 35 at the engaging portion 32 on a rear side thereof in the longitudinal direction of the vehicle body. An engaging stay 85 which is engaged with the engaging flange 59 formed on the housing 41 of the tail lamp device 40 is formed on a lower portion of the lower cover 35. A line 69 is connected to the socket 55 of the break lamp bulb 44. A recessed portion 41a which enhances a light distribution characteristic of the tail lamp bulb 43 (see FIG. 13, FIG. 14) is formed on a lower portion of a rear portion of the housing 41.

FIG. 13 is a cross-sectional view taken along a line 13-13 in FIG. 3. As described previously, the tail lamp device 40 is formed into a curved shape projecting toward a rear side of the vehicle body as viewed in a plan view and hence, on a front side of the vehicle body at the center in the vehicle widthwise direction, a space is formed where a socket 78 having a cover 79 to which a line 80 is connected and the like are efficiently arranged. The partition plate 46 arranged between the break lamp reflector portion 47 and the tail lamp reflector portion 50 extends toward a rear side of the vehicle body to a position close to a back surface of the inner lens 70. The tail lamp bulb 43 is arranged at a position below the exposed surface 40L, 40R (see FIG. 3) in the vertical direction of the vehicle body in a state where a bulb axis J extends upwardly. Due to such a constitution, it is possible to have the direction of an illumination light from the tail lamp bulb 43 easily directed toward an upper side of the vehicle body, and mounting and dismounting of the tail lamp bulb 43 from below the tail lamp device 40 can be performed easily.

FIG. 14 is a cross-sectional view taken along a line 14-14 in FIG. 3. The upper fixing portion 71 of the inner lens 70 is fixed to the outer lens 42 by the fastening bolts 65. Since the upper fixing portion 71 and the fastening screw 65 are covered with the upper cover 31 and hence, an external appearance of the motorcycle 1 is maintained. Further, the tail lamp bulb 43 is mounted on a bottom portion of the tail lamp reflector portion 50 and hence, it is possible to make a mounting portion of the tail lamp bulb 43 barely visible from the outside. In this embodiment, to prevent a case where an illumination light from the tail lamp bulb 43 passes through the lower cover 35 and is viewed from the outside, light blocking treatment is performed such that a reflection surface formed by aluminum vapor deposition, silver coating or the like is formed on a portion 35a of the lower cover 35 which overlaps with the tail lamp valve 43 as visible from a rear side of the vehicle body. This surface treatment may be also applied to a portion 42a of the outer lens 42 or the inner lens 70.

A shape and the structure of the tail lamp device, the numbers and the configurations of the respective bulbs, materials and shapes of the housing, the outer lens and the inner lens, the lens cut structures of the respective lens, a shape of the opening portion of the exposed surface, the structure of exterior parts such as the upper cover, the lower cover and the rear side cowls which form the opening portion are not limited to the above-mentioned embodiment, and various modifications are conceivable. The tail lamp device according to the present invention is not limited to a motorcycle and is applicable to various kinds of vehicles such as a saddle-ride type three-wheeled vehicle or four-wheeled vehicle.

In a tail lamp device (40) according to a first technical feature of the embodiment, only an exposed surface (40L, 40R) faces a rear side of a vehicle body through an opening portion (90) formed in a vehicle body cover (25, 31, 35) and forms a light emitting face. The tail lamp device (40) includes a tail lamp bulb (43) which constitutes a light emitting source of a tail lamp which functions as a position light is arranged at a position either above or below the exposed surface (40L, 40R) in the vertical direction of the vehicle body and also at a position where the tail lamp bulb (43) overlaps with the vehicle body cover (35) as viewed from a rear side of the vehicle body.

In a tail lamp device (40) according to a second technical feature of the embodiment, the tail lamp bulb (43) is arranged at a position below the exposed surface (40L, 40R) in the vertical direction of the vehicle body such that a bulb axis (J) extends upwardly.

In a tail lamp device (40) according to a third technical feature of the embodiment, a tail-lamp reflector portion (50) which emits light from the tail lamp bulb (43) is formed on a housing (41) of the tail lamp device (40), the tail-lamp reflector portion (50) is formed into a shape which allows the tail-lamp reflector portion (50) to house the tail lamp bulb (43) and to cover an area of the exposed surface (40L, 40R), and the tail lamp bulb (43) is arranged close to the exposed surface (40L, 40R).

In a tail lamp device (40) according to a fourth technical feature of the embodiment, a lower edge (57) of the opening portion (90) is formed into an L shape having a corner portion (57a), and the tail lamp bulb (43) is arranged in the vicinity of the corner portion (57a).

In a tail lamp device (40) according to a fifth technical feature of the embodiment, the exposed surface (40L, 40R), the opening portion (90) and the tail lamp bulb (43) are formed of a pair of left and right exposed surfaces (40L, 40R), a pair of left and right opening portions (90) and a pair of left and right tail lamp bulbs (43) respectively in the vehicle widthwise direction, and lower edges (57) of the respective opening portions (90) are formed in a downwardly inclined manner toward the outside in the vehicle widthwise direction, and the tail lamp bulb (43) is arranged at a position close to the center in the vehicle widthwise direction.

In a tail lamp device (40) according to a sixth technical feature of the embodiment, the left and right tail-lamp reflector portions (50) which form a pair are communicated with each other through a communication portion (63) at a portion which is covered by the vehicle body cover (35) at the center in the vehicle widthwise direction.

In a tail lamp device (40) according to a seventh technical feature of the embodiment, light blocking treatment which prevents an illumination light of the tail lamp bulb (43) from passing through the vehicle body cover (35) or the outer lens (42) rearwardly in the longitudinal direction of the vehicle body is applied to the vehicle body cover (35) or to the outer lens (42) positioned behind the tail-lamp reflector portion (50) in the longitudinal direction of the vehicle body.

In a tail lamp device (40) according to an eighth technical feature of the embodiment, the tail lamp bulb (43) is inserted and fixed to the tail-lamp reflector portion (50) from below the vehicle body, and the tail lamp bulb (43) is removable by removing the vehicle body cover (35) positioned behind the tail lamp bulb (43) in the longitudinal direction of the vehicle body from the vehicle body.

According to the first technical feature of the embodiment, the tail lamp bulb which constitutes the light emitting source of the tail lamp which functions as the position light is arranged at the position either above or below the exposed surface in the vertical direction of the vehicle body and also at the position where the tail lamp bulb overlaps with the vehicle body cover as viewed from the rear side of the vehicle body. Due to such a constitution, it is unnecessary to additionally provide a cover member which covers the tail lamp bulb, and it is possible to prevent the tail lamp bulb from being directly visible from the outside. Accordingly, the increase in the number of parts can be prevented, and the light emitting face can ensure a sufficiently large area without being enlarged in the lateral direction. Further, the degree of freedom in laying out the bulb can be enhanced.

According to the second technical feature of the embodiment, the tail lamp bulb is arranged at the position below the exposed surface in the vertical direction of the vehicle body such that the bulb axis extends upwardly. Due to such a constitution, the direction of an illumination light from the tail lamp bulb can be easily directed toward an upper side of the vehicle body. Further, the mounting and the removal of the tail lamp bulb can be performed easily from below the tail lamp device.

According to the third technical feature of the embodiment, the tail-lamp reflector portion which emits light from the tail lamp bulb is formed on the housing of the tail lamp device, the tail-lamp reflector portion is formed into a shape which allows the tail-lamp reflector portion to house the tail lamp bulb and to cover the area of the exposed surface, and the tail lamp bulb is arranged close to the exposed surface. Due to such a constitution, a portion of the exposed surface can be illuminated by an illumination light of the tail lamp bulb while preventing the table lamp bulb from being visible from the outside. Further, the tail lamp bulb is arranged close to the exposed surface and hence, for example, even when the tail-lamp reflector portion is formed into an elongated shape having a bent portion (for example, an L shape), it is possible to make the whole tail-lamp reflector portion having an elongated shape emit light uniformly by arranging the tail lamp bulb close to the bent portion.

According to the fourth technical feature of the embodiment, the lower edge of the opening portion is formed into an L shape having the corner portion, and the tail lamp bulb is arranged in the vicinity of the corner portion. Due to such a constitution, the tail lamp bulb can be arranged in an approximately triangular region formed at the center in the vehicle widthwise direction and below the opening portion. Accordingly, the tail lamp bulb can be arranged below the opening portion while inhibiting a size of the tail lamp device in the vertical direction.

According to the fifth technical feature of the embodiment, the exposed surface, the opening portion and the tail lamp bulb are formed of a pair of left and right exposed surfaces, a pair of left and right opening portions and a pair of left and right tail lamp bulbs respectively in the vehicle widthwise direction, and the respective lower edges of the opening portions are formed in a downwardly inclined manner toward the outside in the vehicle widthwise direction, and the tail lamp bulb is arranged at the position close to the center in the vehicle widthwise direction. Due to such a constitution, the tail lamp bulb can be arranged in an approximately triangular region formed at the center in the vehicle widthwise direction and below the opening portion. Accordingly, the tail lamp bulb can be arranged below the opening portion while inhibiting a size of the tail lamp device in the vertical direction.

According to the sixth technical feature of the embodiment, the left and right tail-lamp reflector portions which form a pair are communicated with each other through the communication portion at the portion which is covered by the vehicle body cover at the center in the vehicle widthwise direction. With the provision of the communication portion, an illumination light of the tail lamp bulb on one side reaches the reflector portion on the other side. Accordingly, it is possible to easily make the left and right reflector portions uniformly emit light. Further, it is possible to acquire the tail lamp device having a peculiar light distribution characteristic that the illumination light of the bulb on the other side is visible from the exposed surface on one side depending on a viewing angle.

According to the seventh technical feature of the embodiment, light blocking treatment which prevents an illumination light of the tail lamp bulb from passing through the outer lens is applied to the vehicle body cover or to the outer lens positioned behind the tail-lamp reflector portion in the longitudinal direction of the vehicle body. Accordingly, it is possible to prevent an illumination light of the tail lamp bulb from passing through the vehicle body cover and the outer lens in the rearward direction of the vehicle body and being viewed from a rear side of the vehicle body.

According to the eighth technical feature of the embodiment, the tail lamp bulb is inserted and fixed to the tail-lamp reflector portion from below the vehicle body, and the tail lamp bulb is removable by removing from the vehicle body the vehicle body cover positioned behind the tail lamp bulb in the longitudinal direction of the vehicle body. Accordingly, a tail lamp bulb exchanging operation can be easily performed.

Obviously, numerous modifications and variations of the present invention are possible in light of the above teachings. It is therefore to be understood that within the scope of the appended claims, the invention may be practiced otherwise than as specifically described herein.

What is claimed is:

1. A tail lamp device for a motorcycle, comprising:
a first tail lamp bulb to emit light as a position light of the motorcycle, the first tail lamp bulb being arranged at a position either above or below a first exposed surface of the motorcycle in a vertical direction of a vehicle body of the motorcycle, the first exposed surface facing a rear side of the vehicle body through a first opening portion provided in a vehicle body cover of the vehicle body, only the first exposed surface forming a light emitting face for the first tail lamp bulb in the motorcycle, the first tail lamp bulb being provided to overlap with the vehicle body cover as viewed from the rear side of the vehicle body.

2. The tail lamp device for a motorcycle according to claim 1, wherein the first tail lamp bulb is arranged below the first exposed surface in the vertical direction of the vehicle body as viewed from the rear side of the vehicle body, the first tail lamp bulb including a bulb axis extending upwardly and being provided to emit light along the bulb axis.

3. The tail lamp device for a motorcycle according to claim 1, further comprising:
a housing provided in the vehicle body; and
a first tail-lamp reflector portion to reflect light emitted from the first tail lamp bulb, the first tail-lamp reflector portion being provided on the housing,
wherein the first tail-lamp reflector portion is formed into a shape which allows the first tail-lamp reflector portion to house the first tail lamp bulb and to cover at least a part of an area of the first exposed surface, and
wherein the first tail lamp bulb is arranged close to the first exposed surface.

4. The tail lamp device for a motorcycle according to claim 1,
Wherein a lower edge of the first opening portion is formed into an L shape having a corner portion, and
wherein the first tail lamp bulb is arranged in a vicinity of the corner portion.

5. The tail lamp device for a motorcycle according to claim 1, further comprising:
a second tail lamp bulb to emit light as a position light of the motorcycle, the second tail lamp bulb being arranged at a position either above or below a second exposed surface of the motorcycle in the vertical direction of the vehicle body, the second exposed surface facing the rear side of the vehicle body through a second opening portion provided in the vehicle body cover, only the second exposed surface forming a light emitting face for the second tail lamp bulb in the motorcycle, the second tail lamp bulb being provided to overlap with the vehicle body cover as viewed from the rear side of the vehicle body,
wherein the first and second tail lamp bulbs are arranged side by side in a vehicle widthwise direction of the vehicle body,
wherein the first and second opening portions are arranged side by side in the vehicle widthwise direction,
wherein a lower edge of the first opening portion is downwardly inclined toward an opposite side of the second opening portion in the vehicle widthwise direction,
wherein a lower edge of the second opening portion is downwardly inclined toward an opposite side of the first opening portion in the vehicle widthwise direction, and
wherein the first and second tail lamp bulbs are respectively arranged at positions close to a center of the vehicle body in the vehicle widthwise direction.

6. The tail lamp device for a motorcycle according to claim 3, further comprising:
a second tail lamp bulb to emit light as a position light of the motorcycle, the second tail lamp bulb being arranged at a position either above or below a second exposed surface of the motorcycle in the vertical direction of the vehicle body, the second exposed surface facing the rear side of the vehicle body through a second opening portion provided in the vehicle body cover, only the second exposed surface forming a light emitting face for the second tail lamp bulb in the motorcycle, the second tail lamp bulb being provided to overlap with the vehicle body cover as viewed from the rear side of the vehicle body,
wherein the first and second tail lamp bulbs are arranged side by side in a vehicle widthwise direction of the vehicle body,
wherein the first and second opening portions are arranged side by side in the vehicle widthwise direction,
wherein a lower edge of the first opening portion is downwardly inclined toward an opposite side of the second opening portion in the vehicle widthwise direction,
wherein a lower edge of the second opening portion is downwardly inclined toward an opposite side of the first opening portion in the vehicle widthwise direction, and
wherein the first and second tail lamp bulbs are respectively arranged at positions close to a center of the vehicle body in the vehicle widthwise direction.

7. The tail lamp device for a motorcycle according to claim 6, further comprising:
a second tail-lamp reflector portion to reflect light emitted from the second tail lamp bulb, the second tail-lamp reflector portion being provided on the housing,
wherein the second tail-lamp reflector portion is formed into a shape which allows the second tail-lamp reflector portion to house the second tail lamp bulb and to cover an area of the second exposed surface, and
wherein the second tail lamp bulb is arranged close to the second exposed surface.

8. The tail lamp device for a motorcycle according to claim 7, further comprising:
wherein the first and second tail-lamp reflector portions which form a pair are communicated with each other through a communication portion at a portion which is covered by the vehicle body cover at the center of the vehicle body in the vehicle widthwise direction.

9. The tail lamp device for a motorcycle according to claim 1, wherein light blocking treatment is applied to the vehicle body cover to prevent an illumination light of the first tail lamp bulb from passing rearwardly through the vehicle body cover in a longitudinal direction of the vehicle body.

10. The tail lamp device for a motorcycle according to claim 1, wherein light blocking treatment is applied to an outer lens to prevent an illumination light of the first tail lamp bulb from passing rearwardly through the outer lens in a longitudinal direction of the vehicle body, the outer lens being positioned behind the first tail-lamp reflector portion in the longitudinal direction of the vehicle body.

11. The tail lamp device for a motorcycle according to claim 1,
wherein the first tail lamp bulb is provided in and fixed to the first tail-lamp reflector portion from below the vehicle body, and
wherein the first tail lamp bulb is removable by removing the vehicle body cover from the vehicle body, the vehicle body cover being positioned behind the first tail lamp bulb in the longitudinal direction of the vehicle body.
